(19) United States
(12) Patent Application Publication
(10) Pub. No.: US 2010/0189842 A1
(43) Pub. Date: Jul. 29, 2010

(54) FLOATING BEVERAGE TOPPING

(75) Inventor: Menachem Toren, Montville, NJ (US)

Correspondence Address: Fleit Gibbons Gutman Bongini & Bianco PL, 21355 EAST DIXIE HIGHWAY, SUITE 115, MIAMI, FL, 33180, US

(73) Assignee: Brand Partner LLC, Rivervale, NJ (US)

(21) Appl. No.: 12/376,793

(22) PCT Filed: Aug. 8, 2007
(86) PCT No.: PCT/IL07/00994

§ 371 Date: Feb. 9, 2009

Related U.S. Application Data
(60) Provisional application No. 60/836,610, filed on Aug. 9, 2006.

(51) Int. Cl. A23G 1/32; A23G 1/50

(52) U.S. Cl. 426/72; 426/631; 426/576; 426/572; 426/541; 426/87; 426/383

(57) ABSTRACT

The presenting invention discloses a floating topping for beverages, comprising cocoa solids and fat, and/or gelatinous compounds such as gelatin, being non-miscible in the beverage's surface, wherein said fat content of said topping is in an amount such that total specific weight of said topping is lower then the total specific weight of said beverage's upper surface layer. The invention also discloses method of producing the same and methods of doing business.

### BACKGROUND OF THE INVENTION

U.S. Ser. No. 60/836,610 “Floating topper” to Menachem Toren, is hereby incorporated by reference in its entirety.

The present invention generally pertains to a floating topping, and more specifically to a topping adapted to float in a beverage which is served either hot or cold.

The multibillion dollar beverage industry is highly competitive and innovative in terms of tastes, types and styles of beverages, all vying for the consumer's attention. Nevertheless one major area which has hitherto been relatively neglected is the physical appearance of the beverage itself. Thus there still remains a long felt need for an attractive original look for served beverages.

### BRIEF DESCRIPTION OF THE DRAWINGS

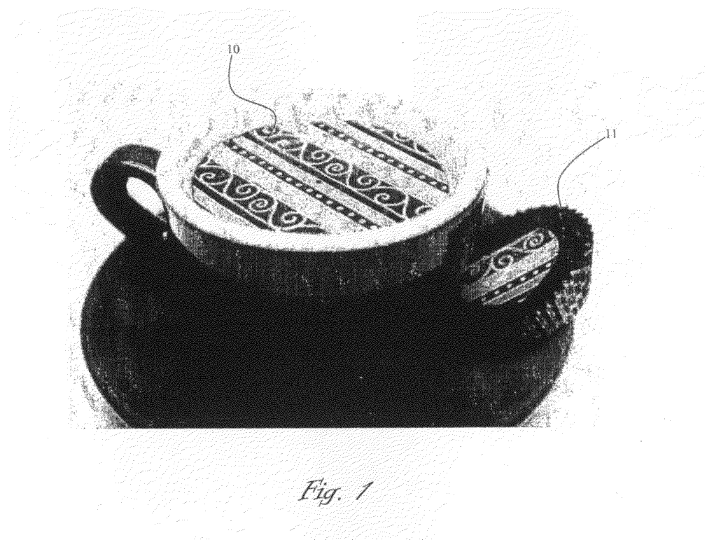

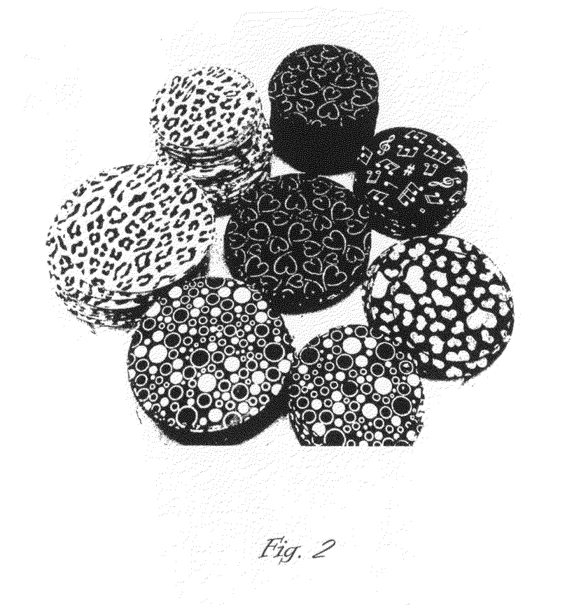

In order to understand the invention and to see how it may be implemented in practice, a plurality of embodiments is adapted to now be described, by way of non-limiting example only, with reference to the accompanying drawings, in which FIG. 1 is a photo presenting two toppings with colored indicia (here presented in gray scale) according to one embodiment of the present invention; and FIG. 2 is a photo presenting various toppings with colored indicia (here presented in gray scale) according to other embodiments of the present invention.

### SUMMARY OF THE INVENTION

It is one object of the invention to disclose a floating topping for beverages, comprising cocoa solids and fat, being non-miscible in said beverage's surface, wherein said fat content of said topping is in an amount such that total specific weight of said topping is lower then the total specific weight of said beverage's upper surface layer.

It is another object of the invention to disclose a topping as defined above, additionally comprising at least one indicia which is made of edible foodstuffs. The topping and/or the indicia topping are at least partially shaped in a pattern of registered design, trademark or logo.

It is still another object of the invention to disclose a method of promoting a sale of a product, goods or services by advertising the same on a beverage topping; said method comprising (i) providing a mass comprising cocoa solids and fat and/or edible gelatinous compounds being non-miscible or slow immiscible in said beverage's surface, wherein said fat or other floating agent content of said topping is in an amount such that total specific weight of said topping is lower then the total specific weight of said beverage's upper surface layer; and (ii) floating said at least one topping in said beverage; wherein said topping is either at least partially shaped in a shape of advertisement, registered design, trademark or logo; or comprises, in at least a portion of its upper face at least one indicia which is shaped or otherwise visually realized as an advertisement, registered design, trademark or logo.

It is lastly another object of the invention to disclose a method of target marketing of product, goods or services by advertising the same on top of selected beverages; said method comprising (i) defining a target market (i.e., at least one segmented market niche); (ii) defining a list of beverages commercially preferred by said segmented market niche; (iii) providing a suitable advertisement which optimally is correlated with both said segmented market niche and said preferable beverage; (iv) providing a mass comprising cocoa solids and fat and/or edible gelatinous compounds being non-miscible or slow miscible in said beverage's surface, wherein said fat or other floating agent content of said topping is in an amount such that total specific weight of said topping is lower then the total specific weight of said beverage's upper surface layer; (v) providing said topping in a shape which visualizes one or more of a group consisting of said suitable advertisement, registered design, trademark or logo; and (vi) floating said at least one topping in said beverage.

### DETAILED DESCRIPTION OF PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, is adapted to remain apparent to those skilled in the art, since the generic principles of the present invention have been defined specifically to provide a floating topping to a beverage and methods thereof.

The term ‘plurality’ refers hereinafter to any integer number equal or higher than 1, e.g., 1 to 10, especially 2 to 4.

The term ‘about’ refers hereinafter to a value being up to ±25% of the defined measure.

The term ‘beverage’ refers in a non-limiting manner to any edible or ingested liquid or mixtures of two or more edible or ingested fluids, for example, the term refers to water and water rich drinks, juices, sodas, and carbonated beverages, iced drinks, alcoholic beverages and non-alcoholic variants, beers, wines, ciders, milk, milked-based drinks, milkshakes, cream and ice-cream products, coffee or cocoa-based drinks, hot beverages, and especially coffee-based beverages such as cappuccino, coffee, espresso, frappe, flavored coffees (e.g., mocha etc.), iced coffee, latte, hot chocolate; hot cider, mulled cider, Gluhwein; tea-based beverages, flavored teas (e.g., chai etc.), green tea, iced tea, pearl milk tea, tea, herbal teas, herbal extracts, roasted grain beverages (e.g., postum etc.), soups, yogurts, porridge, paste, gruel, oatmeal, cereal breakfast dishes, puddings, iced beverages, frozen beverages, etc.

RGB color model is an additive model in which red, green, and blue are combined in various ways to reproduce other colors. The term ‘RGBA’ is also used to mean Red, Green, Blue, Alpha, wherein Alpha is used for transparency. At least a portion of the colors of the product is provided in a non-limiting manner in metallic colors; especially colors selected from stainless-steel, gold and silver colors.

It is thus in the scope of the invention wherein a floating topping for beverages is disclosed. The topping comprises inter alia cocoa solids and fat. The topping is non-miscible or at least partially miscible in said beverage's surface. It is in the scope of the invention wherein said non-miscibility or partially miscibility is effective for no more than the first about 10 minutes or so of immersing or floating said topping in said beverage. For the sake of clarity, the terms of immiscibility and partial immiscibility for the first about 10 minutes will be referred to interchangeably in one term, namely, ‘immiscible’. The fat content of the topping is in an amount such that total specific weight of the topping is lower then the total specific weight of the beverage's upper surface layer.

It is also in the scope of the invention wherein the aforesaid topping is immiscible or and floating in hot beverage, e.g., from about 38° C. to about 60° C. Alternatively or additionally, it is in the scope of the invention wherein the topping is immiscible and floating in cold beverages and beverages served in ambient temperature, e.g., from about −20° C. to about 38° C.

It is also in the scope of the invention wherein the cocoa solids content is between 0.5% to 99% (wt), and wherein the fat content is between about 1% to about 85% (wt).

It is also in the scope of the invention wherein the aforesaid topping additionally comprises one or more additives selected in a non-limiting manner from a group consisting of flavoring agents, sweeteners (e.g., sugars, caramel, fructose etc), artificial sweeteners (aspartame™ etc), perfuming agents (e.g., esters characterized by fruit smell, smells of roasted coffee, caramel etc), floating agents (e.g., edible compositions with total specific weight lower than about 0.98 g cm⁻³ such as fat, oils etc), stabilizers (e.g., edible polymers and oligomers, carbohydrates etc), emulsifiers (e.g., lecithin, phospholipids, commercially available edible surfactants etc), de-emulsifiers, decorative means, colorants, pigments, nutrients, slow release compounds, buffers, salts, vitamins, milk, milk products, cream, butter, commercially available butter substitutes, foaming agents, solvents (e.g., edible and/or volatile fluids and liquids characterized by total specific weight lower than about 0.98 g cm⁻³), water-immiscible fluids and edible waxes, alcohols, foam, edible acids, bubbles producing means (e.g., soluble or dispersible carbon dioxide generators); powders, editable polymers, editable solids and powders, indicators, aromatic substances, terpenes and terpene-like compounds, test enhancers, fats, butter oleinoils, cocoa butter equivalents (CBEs), CBEs comprising e.g., mixtures of about 25 to about 75% (wt) cocoa butter and about 5 to about 50% (wt) butter oleinoils, esters formed from glycerol and fatty acids, mono-glycerides, di-glycerides, tri-glycerides, starches, proteins and amino acids, antioxidants, plants or parts thereof, especially fruits, leaves, stems or roots, edible ink and especially edible ink-jet ink, or any combination thereof.

It is also in the scope of the invention wherein the total specific weight of said topping is between about 0.75 to about 1.05 g cm⁻³, especially between about 0.82 to about 0.95 g cm⁻³.

It is also in the scope of the invention wherein the fat comprises about 5% to 100% (wt) cocoa butter.

It is also in the scope of the invention wherein the content of cocoa solids or fat is zero or low, e.g., between 0 to 50% (wt), and further comprising edible gelatinous compounds, e.g., between about 0.5 to about 75% (wt), especially gels, gelling agents, gelatin and otherwise gelatinous agents (agars, agarose, pectins etc). This cocoa-free or cocoa-poor gelatinous topping is possibly is at least partially transparent or characterized by mat colors. Moreover, this gelatinous topping is possibly comprises buoyancing fluids accommodated within its mass; such as air or carbon dioxide gasses, alcoholic fluids etc, which increase said topping's floatability.

It is also in the scope of the invention wherein the topper of the present invention is adapted to provide an elegant way of serving and decorating beverages ad defined above. Hence for example, this topper is utilizable in weddings, pubs, birthday parties etc.

It is also in the scope of the invention wherein the topping as defined in any of the above comprising a plurality of indicia (e.g., one, two or more) applied to the topping's upper (or visible) face. It is also in the scope of the invention wherein the indicia is applied in the topping's bottom face, side faces, or in combination of lower and upper face. The thickness of the indicia is possibly varies e.g., from 1 μm or less to about 10 mm or more.

It is also in the scope of the invention wherein at least one indicia is doped, immersed, coated, impregnated, solubilized, dispersed, glued, melted, ink-jetted, sprayed, or otherwise applied on top of at least a portion of the topping top (or visible) face.

It is also in the scope of the invention wherein the indicia are at least partially made of commercially available edible foodstuffs.

It is also in the scope of the invention wherein the indicia provided in either gray (i.e., black and white mixtures) or color scale, said color is either single or multiple-color; said multiple-color is either full-process colors or RGB or RGBA scales or other commercially available scales, metallic colors etc.

It is also in the scope of the invention wherein the aforesaid indicia is provided by (1) either texturized or untexturized single dimension, two dimensions (2D) and/or three dimensions (3D) configuration; (ii) either shaped, especially in a registered design, trademark or logo, or not shaped; (iii) either single or multiple layered structure, said layers are provided in parallel (a stack arrangement for example), perpendicular, tilted manner or a combination thereof; (iv) either rigid or at least partially non-rigid (e.g., gel-like, foam-like) texture; and/or emphasized by at least one parameter selected from a group consisting of drawing, decorative pattern, shape, text, graphics, colors, photo, logo, trademark, design, data presentation or any combination thereof.

It is also in the scope of the invention wherein the topping is at least partially shaped in a shape of registered design, trademark or logo, such that the contour or inner portion of the topping is provided in a recognizable manner.

It is also in the scope of the invention wherein the indicia (i) comprises commercial advertising; and/or (ii) at least partially shaped in a shape of registered design, trademark or logo.

It is also in the scope of the invention wherein the topping is characterized in a non-limiting manner by (i) either texturized, partially-texurized or untexturized single dimension, 2D and/or 3D configuration; (ii) either rigid or at least partially non-rigid texture; (iii) either continuous or discontinuous (e.g., net-like) upper surface; (iv) either regular or irregular (e.g., star-like) circumference; (v) polygonal, rounded, curved, patterned, partially patterned or non-patterned circumference; (vi) either homogeneous or heterogeneous composition, size, width (e.g., partially thin and partially wide), texture (e.g., partially smooth and partially texurized or apertured), test (e.g., sweet and sour), color (e.g., half black and half white colors) or shape (e.g., partially polygonal and partially rounded); (vii) single or multiple layered structure, or (viii) any combination thereof.

It is also in the scope of the invention wherein the topping is characterized by any taste and flavor, e.g., tastes and flavors selected in a non-limiting manner from a group consisting of commercially available, new or exotic flavors of chocolate, coffee, herbs, fruits, mints or any mixture thereof. It is also in the scope of the invention wherein a method of decorating a beverage by at least one topping is disclosed. The method comprises in a non-limiting manner the steps of (i) providing a mass comprising cocoa solids and fat or gelatinous compounds, being non-miscible in the beverage's surface, wherein the fat or other floating agent content of said topping is in an amount such that total specific weight of said topping is lower then the total specific weight of the beverage's upper surface layer; and (ii) then, floating said at least one topping in said beverage.

It is also in the scope of the invention wherein the topping utilized for the aforesaid method is either (i) at least partially shaped in the shape of advertisement, registered design, trademark or logo; or (ii) comprises, in at least a portion of its upper face, at least one indicia which is shaped or otherwise visually realized as an advertisement, registered design, trademark or logo. The indicia (i) possibly comprise a commercial advertisement; and/or (ii) at least partially shaped or otherwise visualized as an advertisement, registered design, trademark or logo.

It is also in the scope of the invention wherein a method of producing the topping as defined in any of the above is disclosed. This production method is comprised in a non-limiting manner from steps selected from (i) providing a sheet-like mass, comprising inter alia cocoa solids and fat, e.g., cocoa butter, for example, and/or gelatinous compounds, wherein the cocoa solids content is between 95% to 1.5% (wt), and wherein the fat content is between 1% to 85% (wt), and optionally up to 75% (wt) of additives as defined above; optionally, the sheet-like mass is further doped, immersed, coated, impregnated, solubilized, dispersed, glued, melts, painted, either manual, automatic or semiautomatic application of materials, ink-jetted, sprayed, or otherwise applied on top, side and/or bottom of at least a portion of said topping face by one or more layers with indicia; (ii) shaping said mass to a predetermined shape, e.g. in a shape characterized by a diameter smaller then the beverage cup inner diameter; (iii) packaging this obtained shaped topping in a one-product package or in a multiple-products packaging, or otherwise floating the topping in a served beverage.

It is also in the scope of the invention wherein a method of promoting the sale of a product, goods or services by advertising the same on a beverage topping is disclosed. The method comprises steps of (i) providing a mass comprising cocoa solids and fat, and/or gelatinous compounds, being non-miscible, or at least slow miscible in said beverage's surface, wherein said fat content of said topping is in an amount such that total specific weight of said topping is lower then the total specific weight of said beverage's upper surface layer; and (ii) floating the at least one topping in the beverage; wherein the topping is either at least partially shaped in the shape of advertisement, registered design, trademark or logo; or comprises, in at least a portion of its face at least one indicia which is shaped or otherwise visually realized as an advertisement, registered design, trademark or logo.

It is also in the scope of the invention wherein a method of target marketing of product, goods or services by advertising the same on top of selected beverages is disclosed. The method comprises steps of (i) defining a target market (i.e., segmented market niche, e.g., children); (ii) defining a list of beverages commercially preferred by said segmented market niche (e.g., cocoa milk served in ambient temperature); (iii) providing a suitable advertisement which optimally is correlated with both said segmented market niche and said preferable beverage (e.g., toys company); (iv) providing a mass comprising cocoa solids and fat and/or gelatinous compounds, being non-miscible or slow miscible in said beverage's surface, wherein the fat content of the topping is in an amount such that total specific weight of the topping is lower then the total specific weight of the beverage's upper surface layer; (v) providing the topping in a shape which visualizes one or more of a group consisting of said suitable advertisement (e.g., a commercially available toy of this toy company), registered design, trademark (e.g,. of this toy company) or logo; and (vi) floating said at least one topping in said beverage, or in this case, promoting the sale of the goods and services those shaped toppings to this targeted market niche, e.g., the children.

It is also in the scope of the invention wherein step (v) is alternatively or additionally comprises of a step of providing, in at least a portion of said topping's face, at least one indicia which shaped, or otherwise visually realized, as said suitable advertisement, registered design, trademark or logo.

Reference is made now to FIG. 1, presenting a topping according to one embodiment of the invention. In this photo, the topping (10) is floating at the upper surface of a hot coffee drink This rounded topping (about 3 mm thick) comprises inter alia about 50% cocoa solids and about 35% cocoa butter. The indicia are ink-jetted edible colored pigments. Topping 11 is a small-diameter shaped (here, heart-shaped) mass (about 6 mm thick), comprising inter alia about 40% cocoa solids and about 20% cocoa butter. This topping is also applied with a thin (about 7.5 μm) ink-jetted edible colored pigment layer.

Reference is made now to FIG. 2, presenting a topping according to yet other embodiments of the invention.

1. A floating topping for beverages, comprising cocoa solids and fat, being non-miscible in said beverage's surface, wherein said fat content of said topping is in an amount such that total specific weight of said topping is lower then the total specific weight of said beverage's upper surface layer.

2. The topping according to claim 1, immiscible and floating in hot beverage.

3. The topping according to claim 1, immiscible and floating in cold beverage.

4. The topping according to claim 1, wherein the cocoa solids content is between 5% to 99% (wt), and wherein the fat content is between 1% to 85% (wt).

5. The topping according to claim 1, wherein the content of cocoa solids or fat is between 0 to 50% (wt); comprising gelatinous compounds, 0.5 to 75% (wt), especially gels, gelling agents, gelatin and otherwise gelatinous agents.

6. The topping according to claim 1, additionally comprising additives selected from a group consisting of flavoring agents, sweeteners, artificial sweeteners, perfuming agents, floating agents, stabilizers, emulsifiers, de-emulsifiers, decorative means, colorants, pigments, nutrients, slow release compounds, salts, edible acids, vitamins, milk, milk products, cream, butter, foaming agents, solvents, water-immiscible fluids, alcohols, foam, bubbles producing means; powders, editable polymers, editable solids and powders, indicators, aromatic substances, terpenes and terpene-like compounds, test enhancers, fats, butter oleinoils, cocoa butter equivalents (CBEs), CBEs comprising mixtures of 25-75% (wt) cocoa butter and 5-50% (wt) butter oleinoils, esters formed from glycerol and fatty acids, mono-glycerides, di-glycerides, tri-glycerides, starches, gels, gelling and gelatinous agents, gelatin, proteins, antioxidants, plants or parts thereof, especially fruits, leaves, stems or roots, edible ink and especially edible ink-jet ink, or any combination thereof.

7. The topping according to claim 1, wherein said total specific weight of said topping is between 0.75 to 1.05 g cm⁻³, especially between 0.82 to 0.95 g cm⁻³.

8. The topping according to claim 1, wherein said fat comprises of 5% to 100% (wt) cocoa butter.

9. The topping according to claim 1, comprising indicia applied to said topping's upper and/or bottom face.

10. The topping according to claim 1, wherein said indicia is doped, immersed, coated, impregnated, solubilized, dispersed, glued, melts, ink-jetted, sprayed, or otherwise applied on top of at least a portion of said topping's top, side and/or bottom face.

11. The topping according to claim 1, wherein said indicia is made of edible foodstuffs.

12. The topping according to claim 1, wherein said indicia provided in either gray (black and white mixtures) or color scale, said color is either single or multiple-color; said multiple-color is either full-process color or RGB or RGBA scales, metallic colors, especially steel, gold and silver colors.

13. The topping according to claim 1, wherein said indicia provided by (i) either texturized or untexturized single dimension, 2D and/or 3D configuration; (ii) either shaped, especially in a registered design, trademark or logo, or not shaped; (iii) either single or multiple layered structure; (iv) either rigid or at least partially non-rigid texture; and/or emphasized by at least one parameter selected from a group consisting of drawing, decorative pattern, shape, text, graphics, colors, photo, logo, trademark, design, data presentation or any combination thereof.

14. The topping according to claim 1, wherein said topping is at least partially shaped in the shape of registered design, trademark or logo.

15. The topping according to claim 1, wherein said indicia (i) comprises commercial advertising; and/or (ii) is at least partially shaped in the shape of registered design, trademark or logo.

16. The topping according to claim 1, characterized by (i) either texturized or untexturized single dimension, 2D and/or 3D configuration; (ii) either rigid or at least partially non-rigid texture; (iii) either continuous or discontinuous upper surface; (iv) either regular or irregular circumference; (v) polygonal, rounded, curved, patterned, partially patterned or non-patterned circumference; (vi) either homogeneous or heterogeneous composition, size, width, texture, test or shape; (vii) single or multiple layered structure, or (viii) any combination thereof.

17. A method of decorating a beverage by at least one topping, comprising (i) providing a mass comprising cocoa solids and fat or gelatinous compounds being non-miscible in said beverage's surface, wherein said fat or other floating agents content of said topping is in an amount such that total specific weight of said topping is lower then the total specific weight of said beverage's upper surface layer; and (ii) floating said at least one topping in said beverage.

18. The method according to claim 17, wherein said topping is either (i) at least partially shaped in a shape of advertisement, registered design, trademark or logo; or (ii) comprises, in at least a portion of its upper face at least one indicia which shaped or otherwise visually realized as an advertisement, registered design, trademark or logo.

19. The method according to claim 18, wherein said indicia (i) comprises commercial advertising; and/or (ii) at least partially shaped or otherwise visually realized as an advertisement, registered design, trademark or logo.

20. A method of promoting a sale of a product, goods or services by advertising the same on a beverage topping; said method comprising (i) providing a mass comprising cocoa solids and fat or gelatinous compounds, being non-miscible in said beverage's surface, wherein said fat or other floating agents content of said topping is in an amount such that total specific weight of said topping is lower then the total specific weight of said beverage's upper surface layer; and (ii) floating said at least one topping in said beverage; wherein said topping is either at least partially shaped in a shape of advertisement, registered design, trademark or logo; or comprises, in at least a portion of its upper face at least one indicia which shaped or otherwise visually realized as an advertisement, registered design, trademark or logo.

21. A method of target marketing of product, goods or services by advertising the same on top of selected beverages; said method comprising (i) defining a target market (segmented market niche); (ii) defining a list of beverages commercially preferred by said segmented market niche; (iii) providing a suitable advertisement which is optimally correlated with both said segmented market niche and said preferable beverage; (iv) providing a mass comprising cocoa solids and fat and/or gelatinous compounds, being non-miscible in said beverage's surface, wherein said fat or other floating agents content of said topping is in an amount such that total specific weight of said topping is lower then the total specific weight of said beverage's upper surface layer; (v) providing said topping in a shape which visualizes one or more of a group consisting of said suitable advertisement, registered design, trademark or logo; and (vi) floating said at least one topping in said beverage.

22. The method according to claim 21, wherein step (v) alternatively or additionally comprises a step of providing, in at least a portion of said topping's upper, side and/or bottom face, at least one indicia which shaped or otherwise visualized as said suitable advertisement, registered design, trademark or logo.
